(19) United States
(12) Patent Application Publication
(10) Pub. No.: US 2024/0424326 A1
(43) Pub. Date: Dec. 26, 2024

(54) FALL PROTECTION SYSTEM

(71) Applicant: Honeywell Safety Products USA, Inc., Charlotte, NC (US)

(72) Inventors: Jan Hrouzek, Brno (CZ); Vaclav Hruza, Brno (CZ); Petr Lopusnik, Brno (CZ)

(21) Appl. No.: 18/338,780

(22) Filed: Jun. 21, 2023

(51) Int. Cl. A62B 35/04; A62B 35/00

(52) U.S. Cl. CPC A62B 35/04; A62B 35/005; A62B 35/0081

(57) ABSTRACT

Systems, assemblies, and/or the like are provided. A fall protection system including an absorber assembly including an absorber body, wherein the absorber body defines a nose portion and a buffer portion, wherein the absorber body is configured to transition from a non-deformed state to a deformed state when the absorber body is subject to one or more loading forces, and wherein the buffer portion is configured to deflect against a rail when the absorber body transitions from the non-deformed state to the deformed state; and a shuttle body configured to secure the fall protection system to a rail. In some embodiments, the absorber body further defines one or more holes configured to distribute the one or more loading forces throughout the absorber assembly during deformation.

### TECHNICAL FIELD

The present disclosure relates generally to fall protection systems. In particular, it relates to an absorber assembly for fall protection systems.

### BACKGROUND

Technicians may use fall protection systems for their own safety when working at altitudes where a fall could cause serious damage to the technicians' bodies, as well as to any equipment they may be carrying. A fall protection system may be integrated with a rail or ladder that the technician is climbing to reach the height where work is required. For example, a fall protection system may have one or more components configured to secure or “anchor” technicians to the rail or ladder, such that if they lose their grip, the fall protection system will secure them to the rail or ladder. During these instances, fall protection systems may need to absorb the dynamic load of the technician, while simultaneously keeping the components of the system from interfering with one another. For example, when undergoing one or more loading forces, one or more components of the fall protection system may be impacted (either with each other or the rail or ladder), causing damage to the system while potentially endangering the safety of the technician and/or the integrity of any equipment.

Through applied effort, ingenuity, and innovation, Applicant has solved problems relating to fall protection systems by developing solutions embodied in the present disclosure, which are described in detail below.

### SUMMARY

In general, embodiments of the present disclosure provide fall protection systems, assemblies, and/or the like.

According to various embodiments, there is provided a fall protection system including an absorber assembly comprising an absorber body, wherein the absorber body defines a nose portion and a buffer portion, wherein the absorber body is configured to transition from a non-deformed state to a deformed state when the absorber body is subject to one or more loading forces, and wherein the buffer portion is configured to deflect against a rail when the absorber body transitions from the non-deformed state to the deformed state; and a shuttle body configured to secure the fall protection system to a rail.

In some embodiments, the absorber body further defines one or more holes configured to distribute the one or more loading forces throughout the absorber assembly during deformation.

In some embodiments, the buffer portion is disposed adjacent to the nose portion on the absorber body.

In some embodiments, the absorber body is a single integrated piece.

In some embodiments, the fall protection system further includes a brake disposed on an underside of the fall protection system, and wherein the buffer portion is disposed adjacent to the brake when the absorber body is in a non-deformed state.

In some embodiments, the absorber assembly includes a shock absorber.

In some embodiments, the fall protection system further includes an attachment mechanism configured to secure the fall protection system to a user, wherein the attachment mechanism is operably engaged with the absorber assembly by a fastening device.

In some embodiments, the attachment mechanism includes a carabiner.

In some embodiments, the attachment mechanism includes a base configured to swivel such that the attachment mechanism is rotatable relative to the absorber assembly.

In some embodiments, the one or more loading forces include one or more forces ranging up to 16 kilo-Newtons.

In some embodiments, the absorber body defines a line of deformation along which the absorber body is configured to transition from the non-deformed state to the deformed state.

In some embodiments, the nose portion is configured to lock with a notch of the rail when the absorber body is in the deformed state.

In some embodiments, the rail is integrated into a ladder.

The above summary is provided merely for purposes of summarizing some example embodiments to provide a basic understanding of some embodiments of the disclosure. Accordingly, it will be appreciated that the above-described embodiments are merely examples. It will be appreciated that the scope of the disclosure encompasses many potential embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 shows a bottom angle view of an operator using a fall protection system in accordance with various embodiments of the present disclosure;

FIG. 2 shows a side angle view of an example fall protection system in accordance with various embodiments of the present disclosure;

FIG. 3 shows a side angle view of an example absorber assembly in accordance with various embodiments of the present disclosure; and

FIG. 4 shows a bottom angle view of an example fall protection system in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

### Overview

According to various embodiments, fall protection systems may be used to ensure the safety of technicians and the integrity of their equipment when working in environments where there is a risk of falling and being severely injured. Fall protection systems may be secured to rails connected to ladders on which technicians are working. When technicians lose their grips, fall protection systems operate to keep them attached to the rail/ladder, thereby reducing damage/injury from a potential fall; this causes the fall protection system to undergo one or more loading forces, which may damage the structural integrity of one or more components of the fall protection system.

In some embodiments, and as will be described in detail in this disclosure, a fall protection system may include an attachment mechanism (which can secure the technician to the system), a shuttle assembly (which can secure the fall protection system to the rail), and an absorber assembly (which can deform and absorb the aforementioned loading forces in the event of a fall). There may also be a fastening device configured to link one or more of these components together to form the fall protection system.

In some embodiments, the absorber assembly may include a body defining, among other things, a nose portion. When the fall protection system undergoes the one or more loading forces, it may contact/collide with the rail/ladder, potentially damaging the absorber assembly and endangering the technician. In some embodiments, the nose of the absorber may be modified to include additional material such that the absorber is buffered against catastrophic contact/collisions with the rail/ladder. The additional material may be created during the fabrication process of the absorber body and/or may be incorporated after the body has been created, according to various embodiments.

### Example Systems and Assemblies

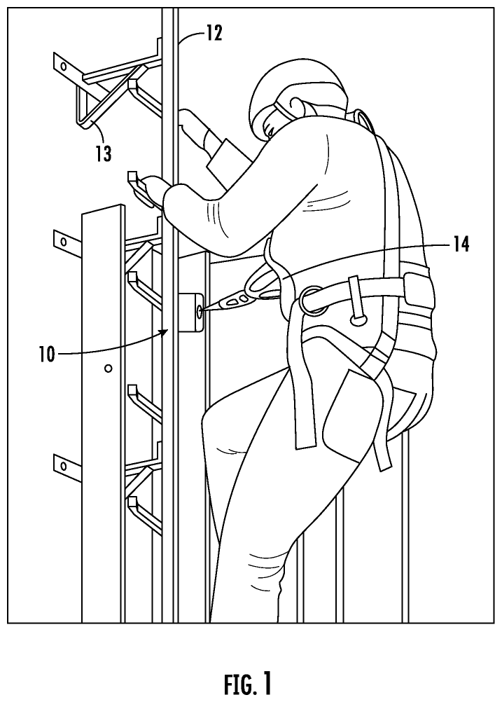

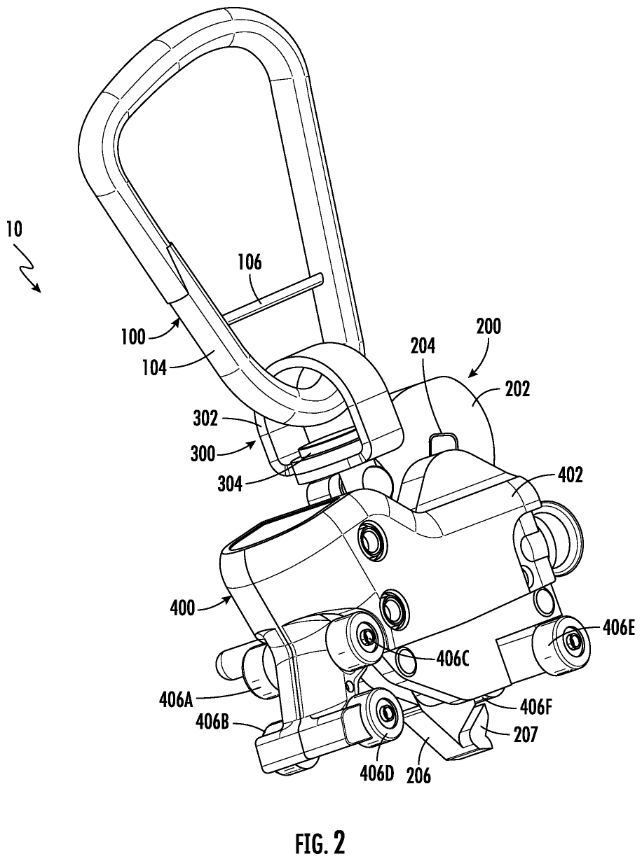

FIG. 1 shows a bottom angle view of a technician using a fall protection system 10 and FIG. 2 shows an angled view of the fall protection system 10, in accordance with various embodiments. FIG. 1 further shows that the fall protection system 10 may be operably engaged to a rail 12 that may be either integrated with or positioned adjacent to a ladder 13. In some embodiments, the fall protection system 10 may be attached to a harness 14 or similar attachment apparel worn by the technician, thereby securing the technician to the rail 12 via the fall protection system 10. As will be described later, the fall protection system 10 may travel along the rail 12 along with the technician (i.e., the fall protection system 10 may slide vertically as the technician ascends or descends the ladder 13).

In some embodiments (referring now to at least FIG. 2), the fall protection system 10 may include an attachment mechanism 100 that may be attached to the harness 14 worn by the technician. In some embodiments, the attachment mechanism 100 may vary in length as necessary as the technician ascends or descends the ladder 13 and the fall protection system 10 moves along the rail 12. In some embodiments, the attachment mechanism 100 may be a carabiner and may further be a solid, ring-shaped body configured to be secured or otherwise fastened to a loop or connection point on the harness 14.

In some embodiments, the attachment mechanism 100 may include a latching mechanism 102. In some embodiments, the latching mechanism 102 may be configured to open or close a loop portion 104 of the attachment mechanism 100. When the loop portion 104 is opened, the attachment mechanism 100 may be secured to one or more other components; that is, one or more components may be secured around or within the loop portion 104. Once the attachment mechanism 100 has been secured to the one or more other components, the latching mechanism 102 may be closed. In some embodiments, the closed latching mechanism 102 may not be opened except by manual input of the technician.

In some embodiments, the attachment mechanism 100 may include a pin 106. The pin 106 may be configured to stretch across the loop potion 104 of the attachment mechanism 100. In some embodiments, the pin 106 may be configured to secure the attachment mechanism 106 to one or more components of the fall protection system 10.

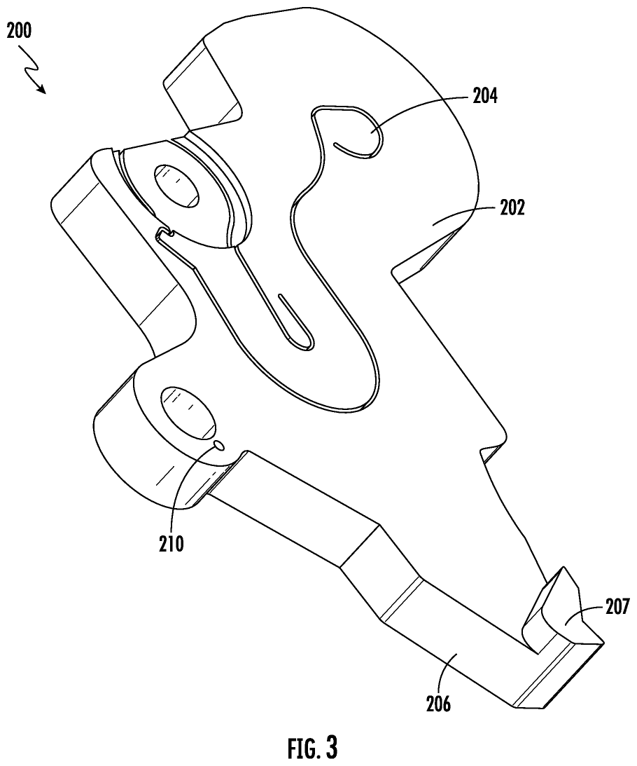

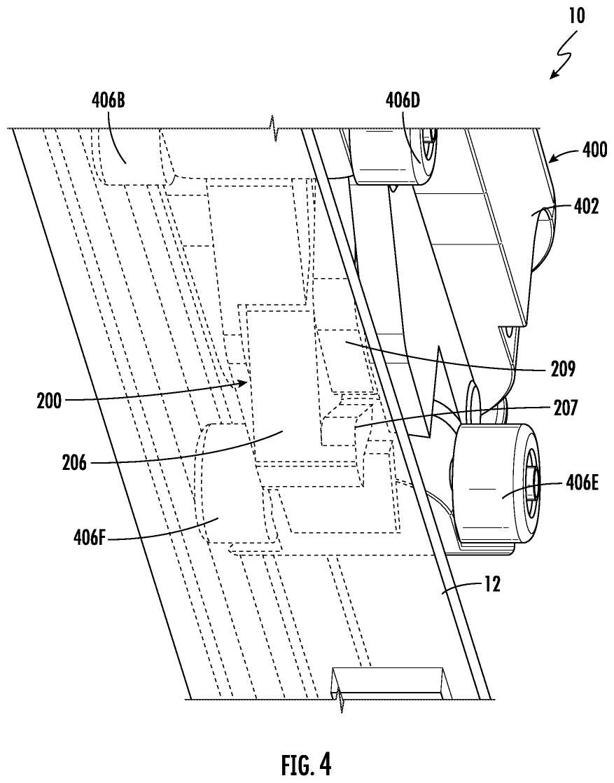

In some embodiments, and referring now to FIGS. 3 and 4, as well as to FIG. 2, the fall protection system 10 may include an absorber assembly 200. In some embodiments, the absorber assembly 200 may include an absorber body 202. The absorber body 202 may be configured to deform when subject to one or more loading forces. In at least this way, the fall protection system 10 may absorb the one or more loading forces and keep the technician secured to the rail 12/ladder 13. In some embodiments, the absorber body 202 may define a line of deformation (LOD) 204. The absorber body 202 may be configured to deform along the LOD 204. In some embodiments, the LOD 204 may divide the absorber body 202 into multiple segments, which may separate along the LOD 204 when the one or more loading forces act on the fall protection system 10. In some embodiments, the LOD 204 may be defined during manufacturing of the absorber assembly 200, such that the absorber body 202 deforms along a desired path/trajectory when the fall protection system is subject to the one or more loading forces.

In some embodiments, the absorber body 202 may define a nose portion 206. In some embodiments, the nose portion 206 may protrude from the absorber body 202. In some embodiments, the nose portion 206 may not be divided by the LOD 204. In some embodiments, the nose portion 206 may be configured to engage with a notch of the rail 12 when the absorber body 202 transitions from a nondeformed to a deformed state. The nose portion 206 may be positioned in proximity to the rail 12 when the fall protection system 10 is engaged to the rail 12. The nose portion 206 may be configured to engage/contact the rail 12 when the absorber body 202 is subject to the one or more loading forces and deforms.

In some embodiments, the absorber body 202 may include a buffer portion 207. In some embodiments, the buffer portion 207 may be disposed adjacent to the nose portion 206. The buffer portion 207 may be a protrusion that juts out from the nose portion 206.

In some embodiments, and as shown in at least FIG. 4, the fall protection system 10 may include a brake 209. In some embodiments, the brake 209 may be a secondary brake and/or an emergency brake configured to deploy if/when the fall protection system 10 is not fixedly attached to the rail 12. In some embodiments, the brake 209 may be disposed on an underside of the fall protection system 10. The brake 209 may be disposed adjacent to the absorber assembly 200.

As shown in at least FIG. 4, the buffer portion 207 may be positioned next to the brake 209, which may be disposed on an underside of the fall protection system 10. In some embodiments, the buffer portion 207 may be an integrated component with the absorber body 202. That is, the buffer portion 207 may be fabricated such that the buffer portion 207 and the absorber body 202 are a single piece. In some embodiments, the buffer portion 207 may be attached to the absorber body 202 after it has been manufactured. In some embodiments, the buffer portion 207 may be augmented to either increase or decrease its size after being manufactured. In some embodiments, the buffer portion 207 may be configured to “absorb” an impact of the absorber body 202 if/when the absorber body 202 contacts the rail 12 after the fall protection system 10 experiences the one or more loading forces.

In some embodiments, the absorber body 202 may define one or more holes 210. In some embodiments, the one or more holes 210 may be distributed throughout the absorber body 202 in order to return the absorber body 202 to a non-deformed state.

In some embodiments, the absorber assembly 200 may be operably engaged with the attachment mechanism 100 via a fastening device 300. In some embodiments, the fastening device 300 may include a loop portion 302. In some embodiments, the loop portion 302 be a solid, half-ring-shaped component through which the attachment mechanism 100 may be connected. The loop portion 104 of the attachment mechanism 100 may be configured to interlock with the loop portion 302 of the fastening device 300 (e.g., via unlatching the latching mechanism 102, interlocking the loop portions 104, 302, and then latching the latching mechanism 102).

In some embodiments, the fastening device 300 may include a base plate 304. In some embodiments, one or more components of the fastening device 300 may be disposed around the base plate 304; in some embodiments, the distribution may be symmetrical. In some embodiments, the base plate 304 may be a swivel. The swiveling base plate 304 may provide 360° rotation of the attachment mechanism 100 relative to the absorber assembly 200. The base plate 304 swiveling may enable a technician to engage with the attachment mechanism 100 in a variety of positions and configuration when using the fall protection system 10.

In some embodiments, the fastening device 300 may include a pin 306. In some embodiments, the pin 306 may be secured through one or more holes in the absorber assembly 200 and the fastening device 300. It will be understood that the pin 306 may be one or more alternative fasteners (e.g., hook-and-loop, adhesive, nut-and-bolt), as desired, to secure the attachment mechanism 100 to the absorber assembly 200.

In some embodiments, the fall protection system 10 may include a shuttle assembly 400 configured to engage with and secure the fall protection system to the rail 12. In some embodiments, the shuttle assembly 400 may be operably engaged to the absorber assembly 200. In some embodiments, the shuttle assembly 400 may include a shuttle body 402.

The shuttle assembly 400 may include one or more wheels 406A-D configured to run along the rail 12, thereby allowing the shuttle assembly 400 to smoothly travel along the rail 12 as the technician climbs the ladder 13. The one or more wheels 406A-D may be attached to the shuttle body 402 (e.g., via one or more fasteners).

Many modifications and other embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A fall protection system comprising:
an absorber assembly comprising an absorber body,
wherein the absorber body defines a nose portion and a buffer portion,
wherein the absorber body is configured to transition from a non-deformed state to a deformed state when the absorber body is subject to one or more loading forces, and
wherein the buffer portion is configured to deflect against a rail when the absorber body transitions from the non-deformed state to the deformed state; and
a shuttle body configured to secure the fall protection system to a rail.

2. The fall protection system of claim 1, wherein the absorber body further defines one or more holes configured to distribute the one or more loading forces throughout the absorber assembly during deformation.

3. The fall protection system of claim 1, wherein the buffer portion is disposed adjacent to the nose portion on the absorber body.

4. The fall protection system of claim 1, wherein the absorber body comprises a single integrated piece.

5. The fall protection system of claim 1, further comprising a brake disposed on an underside of the fall protection system, and wherein the buffer portion is disposed adjacent to the brake when the absorber body is in the non-deformed state.

6. The fall protection system of claim 1, wherein the absorber assembly comprises a shock absorber.

7. The fall protection system of claim 1, further comprising an attachment mechanism configured to secure the fall protection system to a user, wherein the attachment mechanism is operably engaged with the absorber assembly by a fastening device.

8. The fall protection system of claim 7, wherein the attachment mechanism comprises a carabiner.

9. The fall protection system of claim 8, wherein the attachment mechanism comprises a base configured to swivel such that the attachment mechanism is rotatable relative to the absorber assembly.

10. The fall protection system of claim 1, wherein the one or more loading forces comprise one or more forces ranging up to 16 kilo-Newtons.

11. The fall protection system of claim 1, wherein the absorber body defines a line of deformation along which the absorber body is configured to transition from the non-deformed state to the deformed state.

12. The fall protection system of claim 1, wherein the nose portion is configured to lock with a notch of the rail when the absorber body is in the deformed state.

13. The fall protection system of claim 12, wherein the rail is integrated into a ladder.
